(19) United States
(12) Patent Application Publication
(10) Pub. No.: US 2006/0020984 A1
(43) Pub. Date: Jan. 26, 2006

(54) Method, apparatus, and computer program product for improving video-on-demand content delivery in regional networks

(75) Inventors: Oliver Keren Ban, Austin, TX (US); Anthony Cappa Spielberg, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/897,331

(22) Filed: Jul. 22, 2004

(51) Int. Cl. H04N 7/173

(52) U.S. Cl. 725/97; 725/86; 725/95

(57) ABSTRACT

A method, apparatus, and computer program product are disclosed for improving video-on-demand (VOD) content delivery in regional networks. A VOD server is coupled to a global VOD network. The global VOD network is coupled to multiple different regional VOD networks. Multiple different clients are coupled to each one of the regional VOD networks. The server receives a request from a first client in a first one of the regional VOD networks to receive a particular video. The first client is coupled to the first one of the regional VOD networks. The server determines whether a second client that is also coupled to the first one of the regional VOD networks has a first block of the particular video. If the second client does have the first block of the video, the server transmits an instruction to the second client to transmit the particular video to the first client. This instruction includes information needed by the second client in order to permit the second client to transmit the video from the second client to the first client. The instruction from the server does not include any video content. The server then refrains from transmitting the particular video to the first client in response to the request from the first client for the particular video.

### BACKGROUND OF THE INVENTION

1. Technical Field

The present invention is directed to data processing systems. More specifically, the present invention is directed to a method, apparatus, and computer program product for improving video-on-demand content delivery in regional networks.

2. Description of Related Art

Currently, “pay-per-view” movies are available via “Cable Television”. The Cable Television supplier makes the pay-per-view movies available at pre-determined times, and subscribers can register to view the movie at the pre-determined times. At those times, the Cable Television supplier transmits the movie via the normal television cable on a special channel reserved for the pay-per-view movies. All subscribers of the pay-per-view movie receive the movie at the same time on the same channel. While this is an effective way to supply a movie to subscribers, many subscribers do not want to be limited as to viewing times; they want to view the movie at a time of their choice.

Traditional video-on-demand (VOD) systems provide users with the flexibility of choosing both the movie that they wish to see as well as the time that they wish to see it. Such a system is modeled using a client-server architecture in which the client consists of a set of users, while the video server contains a number of disks on which the videos are stored. Whenever a request for a video is made by a client, its blocks are fetched from the disks by a centralized VOD server, and transferred from the server to each client.

“Video-on-demand” refers to the furnishing of a video movie from a server to viewers, or clients, via a computer network at times selected by each viewer and under the control of the viewer. One or more copies of the movie are stored, each on a separate direct access storage device such as disk. Upon request by the viewer, the server bills the viewer for the movie, or video, and transmits the content of the requested video to the viewer. Thus, the server has two functions to perform when the server receives a request from a client: the server bills the client and the server delivers content of the requested video to that client.

Known VOD networks typically are divided into smaller regional networks supported by one large global network. Thus, the VOD server is coupled to the large global network which turn is coupled to multiple different smaller regional networks. Viewers, or clients, are then coupled to the various regional networks. When a server transmits a video, it transmits the content of the video to the global network which then transmits it to the appropriate regional network which then transmits it to the client.

The capacity of the entire VOD network limits the performance of the VOD system. This problem can arise because a particular viewer has requested a very large video through a network that is not capable of efficiently transmitting such a large file, or because there are too many viewers at a particular peak time.

The server is responsible for transmitting content to each client that requested it, regardless of the location of each client. For example, a client in one regional network might request a particular video. A very short time later, another client from the same regional network may request the same particular video. According to the prior art, the server will transmit the content of the video to the first client in response to the first client's request. The server will then also transmit the content of the same video to the second client in response to the second client's request. Bandwidth of the global and regional networks is then taken up transmitting two copies of the same video, at approximately the same time, through the same regional network and then to different clients on that same regional network.

Therefore, a need exists for a method, apparatus, and computer program product for improving video-on-demand content delivery in regional networks.

### SUMMARY OF THE INVENTION

A method, apparatus, and computer program product are disclosed for improving video-on-demand (VOD) content delivery in regional networks. A VOD server is coupled to a global VOD network. The global VOD network is coupled to multiple different regional VOD networks. Multiple different clients are coupled to each one of the regional VOD networks. The server receives a request from a first client in a first one of the regional VOD networks to receive a particular video. The first client is coupled to the first one of the regional VOD networks. The server determines whether a second client that is also coupled to the first one of the regional VOD networks has a first block of the particular video. If the second client does have the first block of the video, the server transmits an instruction to the second client to transmit the entire particular video to the first client. This instruction includes information needed by the second client in order to permit the second client to transmit the video from the second client to the first client. The instruction from the server does not include any video content. The server then refrains from transmitting the particular video to the first client in response to the request from the first client for the particular video.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a high level block diagram of a video-on-demand network in accordance with the present invention;

FIG. 2a depicts a high level flow chart that illustrates a client receiving video content from a server or another client in accordance with the present invention;

FIG. 2b illustrates a high level flow chart that depicts a client receiving an instruction, from a server, that instructs the client to transmit video content from the client to another client in accordance with the present invention;

FIG. 3 depicts a high level flow chart that illustrates a server receiving a request for a video from a first client and in response the server transmitting either video content to the first client or transmitting an instruction to another client to transmit the video to the first client in accordance with the present invention;

FIG. 4a is a block diagram of an entire video that has been divided into blocks of data in accordance with the present invention;

FIG. 4b is a diagram of a buffer at time “t” that is included in a client for storing data that is received by the client in accordance with the present invention;

FIG. 4c is a diagram of the buffer of FIG. 4b at time “t+n” in accordance with the present invention; and

FIG. 5 is a more detailed illustration of a computer system that may be used to implement any of the computer systems of FIG. 1 in accordance with the present invention.

### DETAILED DESCRIPTION OF THE PREFERRED EMBODIMENT

A preferred embodiment of the present invention and its advantages are better understood by referring to the figures, like numerals being used for like and corresponding parts of the accompanying figures.

The present invention is a method, apparatus, and computer program product for improving video-on-demand content delivery in regional networks. According to the present invention, when a first client requests a particular video, the server bills the first client and then determines whether another client in the same regional network to which the first client is coupled is receiving that same video. If the other client still has a copy of the first block of the video in the other client's buffer, the server will send a network packet to the other client that instructs the other client to transmit the content of the video to the first client. Thus, the server still performs the billing function but, in some cases, has shifted the content delivery function from the server to a client.

The server provides to the other client all information that is needed by the other client in order to send a network packet to the first client. The network packet transmitted to the other client includes the network address of the first client as well as information about the requested video, such as video title, video length, and time the first client wants to view the video.

This network packet transmitted by the server to the other client will not include any video content. Thus, the server will not transmit the video content to the first client. Instead, the server transmits an instruction to the other client that instructs the other client to transmit the content to the first client.

If the server cannot locate another client in the same regional network that still has the first block of the video stored within it, the server will transmit the content of the video to the first client.

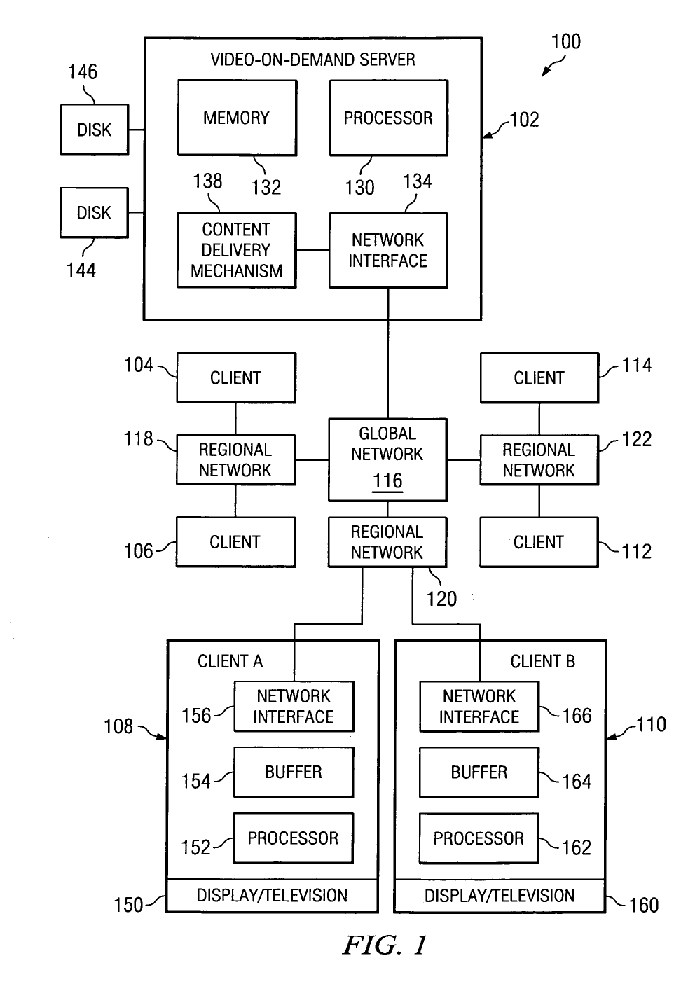

FIG. 1 is a high level block diagram of a video-on-demand network 100 in accordance with the present invention. Network 100 includes a video-on-demand server 102 that delivers videos to a plurality of clients 104, 106, 108, 110, 112, and 114 utilizing a global network 116 and several regional networks 118, 120, and 122.

Video-on-demand server 102 includes a processor 130, a memory 132, a network interface 134 and a content delivery mechanism 138. Video-on-demand server 102 is coupled to one or more storage devices, such as disks 144 and 146.

Content delivery mechanism 138 is used to generate network packets that network interface 134 will transmit to global network 116. Content delivery mechanism 138 will generate packets that include a header file and a data payload. The header file includes information required by the network protocol for network communications such as destination client address, source address, and error checking information. The data payload will include either the content of a requested video, or information that is necessary to generate a network packet that conforms to the network protocol and an instruction to send video content.

For example, when server 102 receives a request from a first client for a particular video, server 102 will determine whether there is another client, in the same regional network which includes the first client, that still has the first block of the video in the second client's buffer. If there is such a second client, the data payload of that network packet will include information such as the network address of the first client as well as an instruction to the second client to start sending the video content to the first client. This network packet is then sent to the second client, not the first client.

Thus, when a second client can be found in the same regional network that still has the video, the server will generate a network packet to send to the second client in response to the request by the first client. The server will not generate a network packet to send to the first client. The server continues, however, to bill the first client. The network packet that the server sends to the second client includes no video content in its data payload. The second client then uses the information it received from the server to generate a network packet to send to the first client. The network packet from the second client includes in its data payload the first block of content of the video requested by the first client. the second client then continues to transmit network packets that include one or more blocks of content of the requested video until the second client has transmitted the entire video to the first client.

When a second client cannot be found in the same regional network that still has the video, the server will generate a network packet to send to the first client in response to the request by the first client. The server will generate a network packet to send to the first client. The network packet that the server sends to the first client includes the content of the requested video in its data payload.

Each client includes a display or television for presenting a video, a processor, a buffer, such as a first-in-first-out (FIFO) buffer, and a network interface. For example, client A 108 includes display/television 150, processor 152, buffer 154, and a network interface 156. Client B 110 includes display/television 160, processor 162, buffer 164, and a network interface 166. These buffers, buffer 154, 164 are preferably FIFO buffers as described below for storing data received from the client's network interface, such as network interface 156, 166.

Server 102 includes an asset manager (not shown) for selecting which copy of an asset (for example, a digital video or movie) to assign to a viewer at a particular client. Server maintains multiple tables to record data about each asset, viewer, disk and asset copy, respectively. Disks 144, 146 store the various videos that are available from server 102 on a single disk or “stripe” a movie on multiple physical disks to expedite access.

An asset table included in server 102 includes information about the various assets, i.e. videos, and indicates the name of the asset, the current number of viewers of the asset, the size in bytes of the asset, the rate at which a copy of the asset is read, a value for the maximum number of viewers expected at any one time, an upper threshold number of viewers for the asset at which the server considers making another copy, a lower threshold number of viewers at which the server considers decreasing the value for the maximum number of viewers and the corresponding number of copies of the asset, and an alert number used to determine when another copy of the asset should be made and the number of outstanding requesters for the asset.

A viewer table included in server 102 indicates viewer identification about each viewer, the name of the asset currently being viewed by the viewer, the copy assigned to the viewer and the point in the copy (or block) at which the viewer is currently viewing. This information also includes information about which blocks of a particular video are currently in a client's buffer.

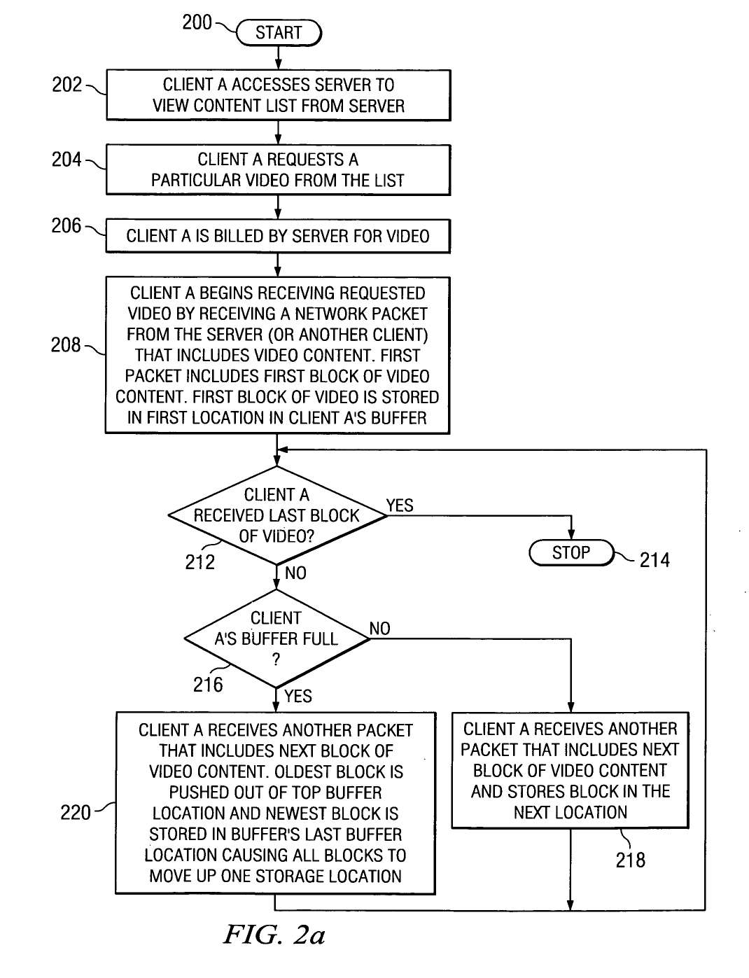

FIG. 2a depicts a high level flow chart that illustrates a client receiving video content from a server or another client in accordance with the present invention. The process starts as depicted by block 200 and thereafter passes to block 202 which illustrates a client, such as client A 108, accessing a video-on-demand server, such as server 102, to view a content list maintained by the server of the various videos that are available to be viewed by the client. Next, block 204 depicts client A requesting a particular video from the list. The process then passes to block 206 which illustrates client A being billed by the server for the video.

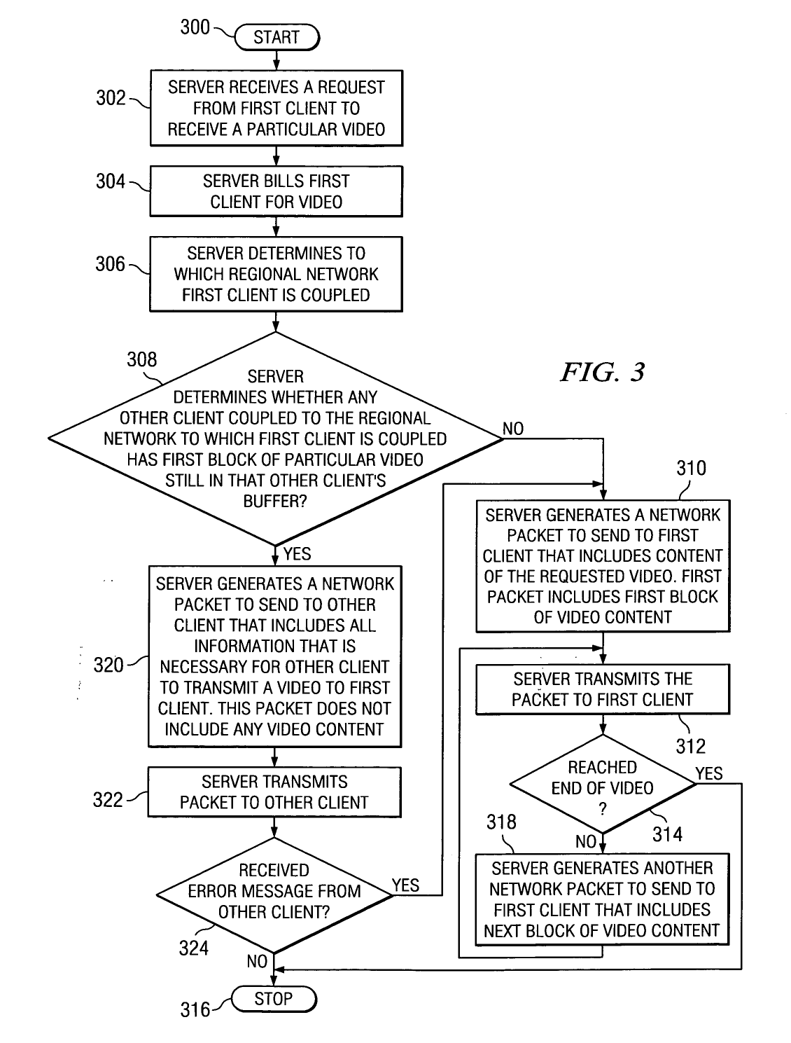

Thereafter, block 208 depicts client A beginning to receive the requested video by receiving a network packet that includes the content of the requested video. This video content is received from either the server or from another client in the network. The first network packet includes the first block of video content. This first block is stored in the first location in the client's FIFO buffer. This first location is either the top or bottom location in the buffer. FIGS. 4a and 4b depict the first location being the bottom location in the buffer.

Next, block 212 illustrates a determination of whether or not client A has received the last block of content of the requested video. If a determination is made that client A has received the last block of video content, the process terminates as illustrated by block 214. Referring again to block 212, if a determination is made that client A has not received the last block of video content, the process passes to block 216 which depicts a determination of whether or not client A's buffer is full of data. If a determination is made that client A's buffer is not full, the process passes to block 218 which illustrates client A receiving another packet that includes the next block of the video. This block of video content is stored in the next buffer location. The process then passes back to block 212.

Referring again to block 216, if a determination is made that client A's buffer is full, the process passes to block 220 which depicts client A receiving another packet that includes the next block of the video. This block of video content is stored in the last buffer location which causes all of the data in the buffer to be pushed up one location which in turn causes the oldest block of data in the buffer to be pushed out of the buffer. The process then passes back to block 212.

Those skilled in the art will recognize that one or more blocks of video content may be included in each network packet. Thus, an entire video may be transmitted in one network packet if the network protocol can accommodate a data payload that is the size of the entire requested video.

FIG. 2b illustrates a high level flow chart that depicts a client receiving an instruction, from a server, that instructs the client to transmit video content from the client to another client in accordance with the present invention. The processes depicted by FIGS. 2a and 2b take place concurrently as described below.

The process starts as depicted by block 226 and thereafter passes to block 227 which illustrates client A currently in the process of receiving video content from either the server or another client, such as depicted by FIG. 2a. Next, block 228 depicts a determination of whether or not client A has received an instruction from the server to transmit the particular video that client A is currently receiving to another client. As described above, this instruction would be included in the data payload of a network packet that client A received from the server. If a determination is made that client A has not received an instruction from the server to transmit the particular video to another client, the process passes back to block 228. Referring again to block 228, if a determination is made that client A has received an instruction from the server to transmit the particular video to another client, the process passes to block 230 which depicts client A retrieving from the network packet that included the instruction all information that client A needs in order for client A to transmit a network packet to client B. The network packet from the server includes a data payload that includes client B's network address, as well as video information such as video title, length of video, time to start the video, and other information. However, the data payload in the network packet from the server will not include any video content. Thus, if the video is a movie, the data payload will include the movie title, length, and time client B wants to start the movie, but will not include any of the movie itself.

Thereafter, block 232 illustrates client A determining whether the first block of the video is still in client A's buffer. If a determination is made by client A that the first block of the video is not still in client A's buffer, the process passes to block 234 which depicts client A generating an error message and sending that error message to the server. The process then terminates as illustrated by block 236.

Referring again to block 232, if a determination is made by client A that client A does not have the first block of video in client A's buffer, the process passes to block 238. Block 238 depicts client A using the information received from the server to generate a network packet for client B that includes a header file that includes client B's network address, and a data payload that includes a copy of the first block of the video. Thus, this network packet includes video content. Block 240, then, illustrates client A transmitting this network packet from client A to client B. Thus, the content of the video is delivered to client B from client A and not from the server.

The process then passes to block 242 which depicts a determination of whether or not client A has transmitted the end of the video, i.e. whether client A has transmitted the last block of video content. If a determination is made that client A has not transmitted the last block of the video, the process passes to block 244 which illustrates client A generating another network packet for client B that includes the next block of the video. The process then passes back to block 240. Referring again to block 242, if a determination is made that client A has transmitted the end of the video, the process terminates as depicted by block 236.

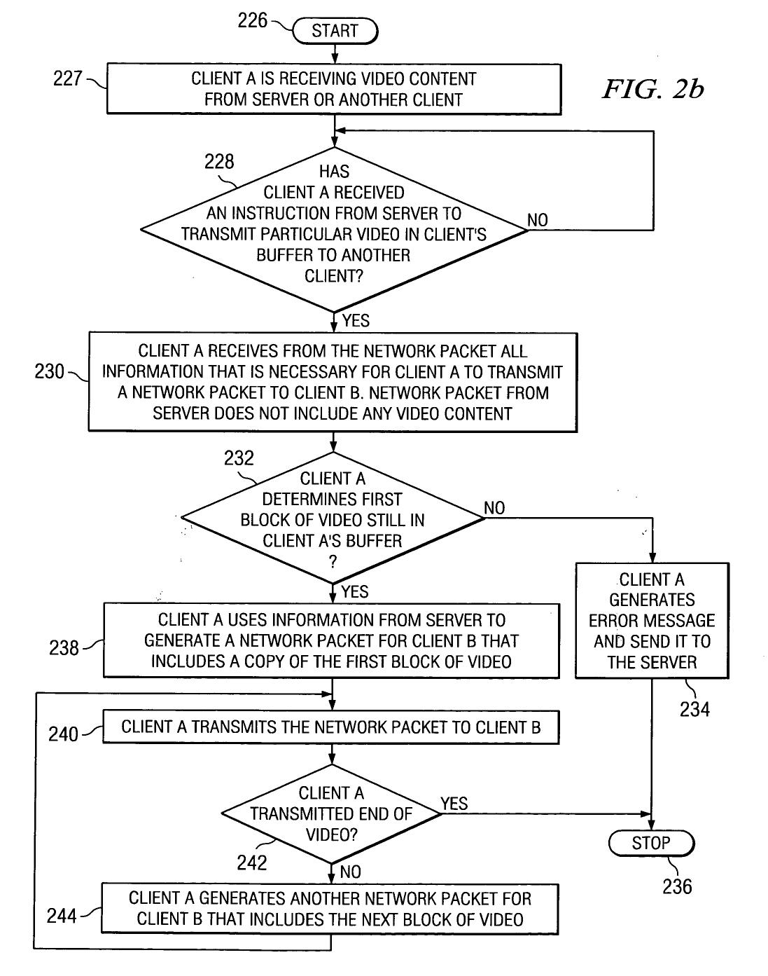

FIG. 3 depicts a server receiving a request for a video from a first client and in response the server transmitting either video content to the first client or transmitting an instruction to another client to transmit the video to the first client in accordance with the present invention. The process starts as depicted by block 300 and thereafter passes to block 302 which illustrates the server receiving a request from a first client, such as client B, to receive a particular video. Next, block 304, depicts the server billing the first client for the video. Next, block 306 illustrates the server determining to which regional network the first client is coupled.

The process then passes to block 308 which depicts a determination by the server of whether any other client that is coupled to this same regional network has the first block of the video still in that other client's buffer. If the server determines that no other client that is coupled to that same regional network has the first block of the video in its buffer, the process passes to block 310. Block 310 illustrates the server generating a network packet to send to the first client that includes the content of the requested video. Thus, the first network packet includes the first block of the video. Next, block 312 depicts the server transmitting this packet to the first client. Thereafter, block 314 depicts a determination of whether or not the server has transmitted the end of the video, i.e. transmitted the last block of the video. If a determination is made that the server has not transmitted the end of the video, the process passes to block 318 which illustrates the server generating another network packet to send to the first client that includes the next block of video content. Referring again to block 314, if a determination is made that the server has transmitted the end of the video, the process terminates as illustrated by block 316.

Referring again to block 308, if the server determines that another client, such as client A, that is coupled to that same regional network has the first block of the video in the client's buffer, the process passes to block 320. Block 320 illustrates the server generating a network packet to send to the other client, i.e. client A, that includes all of the information that is necessary or needed by the other client for the other client to be able to transmit a video to the first client, e.g. client B. This packet does not include any video content.

Next, block 322, depicts the server transmitting the packet to the other client. Thereafter, block 324 illustrates a determination of whether or not the server has received an error message from the other client. This error message would indicate that the other client did not have the first block of video content in the its buffer. If a determination is made that the server has received an error message, the process passes to block 310. Referring again to block 324, if a determination is made that the server has not received an error message, then the other client will be able to transmit the video content so the process terminates as depicted by block 316 without the server transmitting the video content.

FIG. 4a is a block diagram of a video divided into blocks of data in accordance with the present invention. A video 400 is depicted. Video 400 includes all of the content of the video. The entire video 400 is divided into blocks of data. Each block includes video content which is part of the entire video 400. For example, video 400 has been divided into blocks 402-416. Block 1 402 includes the first block of video content while block 8 416 includes the last block of vide content.

FIG. 4b is a diagram of a buffer at time “t” that is included in a client for storing data that is received by the client in accordance with the present invention. Buffer 420 is a FIFO buffer. FIGS. 4a and 4b depict the first location of the buffer being the bottom location. Other FIFO buffers could be used that use the top location as the first location of the buffer.

Thus, when a client that includes buffer 420 requests to receive video 400, video 400 is transmitted by first transmitting block 1 402. Block 1 402 is stored in the first, e.g. bottom, buffer location. Block 2 404 is then transmitted and stored in the next buffer location. This process continues until all of the video has been transmitted.

Buffer 420 includes only six locations. Therefore, buffer 420 can hold only six blocks of video 400 at one time. After block 6 412 is stored, buffer 420 is full. When block 7 414 is transmitted, it causes block 1 402 to be pushed out of buffer 420. Similarly, when block 8 416 is transmitted, it causes block 2 404 to be pushed out of buffer 420.

FIG. 4c is a diagram of the buffer of FIG. 4b at time “t+n” in accordance with the present invention. At time “t+n”, block 8 416 has already been transmitted to and stored in buffer 420 and other data 422, perhaps the content of another video, has been received in buffer 420. Thus, when other data 422 was received by and stored within buffer 420, it caused block 3 406 to be pushed out of buffer 420.

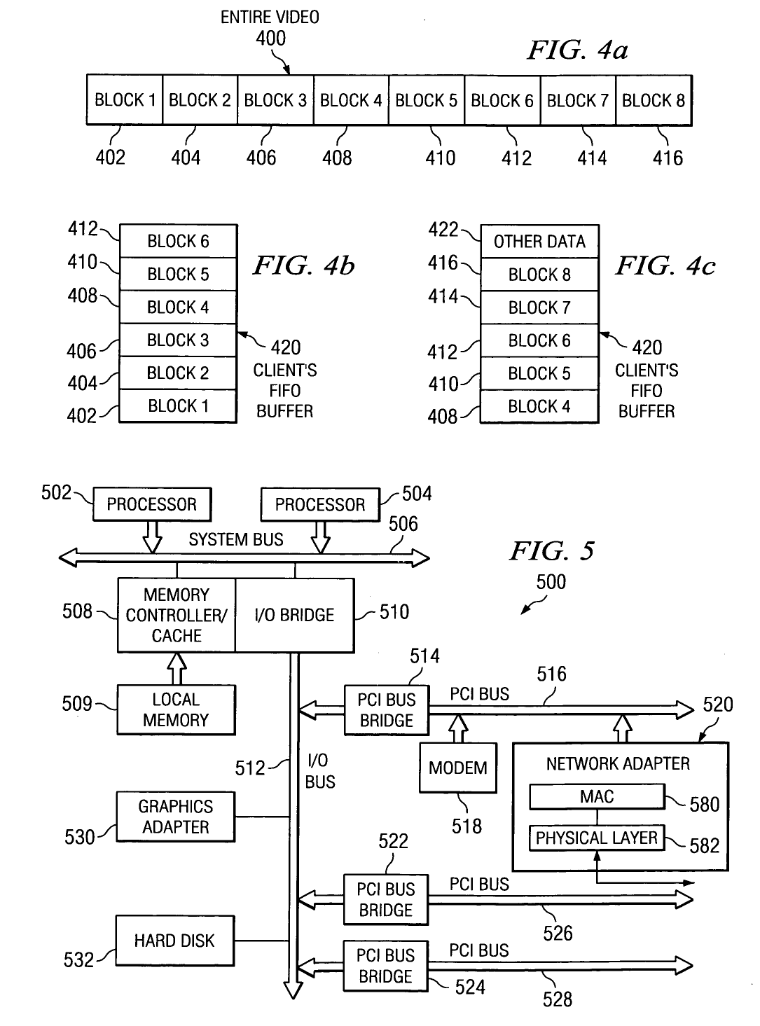

FIG. 5 is a more detailed illustration of a computer system that may be used to implement any of the computer systems of FIG. 1 in accordance with the present invention. Data processing system 500 may be a symmetric multiprocessor (SMP) system including a plurality of SMT capable processors 502 and 504 connected to system bus 506. Alternatively, a single processor system may be employed. Also connected to system bus 506 is memory controller/cache 508, which provides an interface to local memory 509. I/O bus bridge 510 is connected to system bus 506 and provides an interface to I/O bus 512. Memory controller/cache 508 and I/O bus bridge 510 may be integrated as depicted.

Peripheral component interconnect (PCI) bus bridge 514 connected to I/O bus 512 provides an interface to PCI local bus 516. A number of modems may be connected to PCI bus 516. Typical PCI bus implementations will support four PCI expansion slots or add-in connectors. Communications links to other network computers may be provided through modem 518 and network adapter 520 connected to PCI local bus 516 through add-in boards.

Network adapter 520 includes a physical layer 582 which conditions analog signals to go out to the network, such as for example an Ethernet network over an R45 connector. A media access controller (MAC) 580 is included within network adapter 520. Media access controller (MAC) 580 is coupled to bus 516 and processes digital network signals. MAC 580 serves as an interface between bus 516 and physical layer 582. MAC 580 performs a number of functions involved in the transmission and reception of data packets. For example, during the transmission of data, MAC 580 assembles the data to be transmitted into a packet with address and error detection fields. Conversely, during the reception of a packet, MAC 580 disassembles the packet and performs address checking and error detection. In addition, MAC 580 typically performs encoding/decoding of digital signals transmitted and performs preamble generation/removal as well as bit transmission/reception.

Additional PCI bus bridges 522 and 524 provide interfaces for additional PCI buses 526 and 528, from which additional modems or network adapters may be supported. In this manner, data processing system 500 allows connections to multiple network computers. A memory-mapped graphics adapter 530 and hard disk 532 may also be connected to I/O bus 512 as depicted, either directly or indirectly.

Those of ordinary skill in the art will appreciate that the hardware depicted in FIG. 5 may vary. For example, other peripheral devices, such as optical disk drives and the like, also may be used in addition to or in place of the hardware depicted. The depicted example is not meant to imply architectural limitations with respect to the present invention.

It is important to note that while the present invention has been described in the context of a fully functioning data processing system. Those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for improving video-on-demand (VOD) content delivery in regional networks, said method comprising:
coupling a VOD server to a plurality of different regional VOD networks;
coupling a plurality of clients to each one of said plurality of regional VOD networks;
receiving, by said server, a request from a first client in a first one of said plurality of regional VOD networks to receive a particular video, said first client being coupled to said first one of said plurality of regional VOD networks;
determining, by said server, whether a second client that is coupled to said first one of said plurality of regional VOD networks has a first block of said video;
in response to said second client having said first block of said video, transmitting, by said server, an instruction to said second client to transmit said particular video to said first client; and
said server refraining from transmitting said particular video to said first client in response to said request from said first client for said particular video.

2. The method according to claim 1, further comprising:
transmitting from said second client to said first client said particular video.

3. The method according to claim 1, further comprising:
in response to said second client not having said first block of said video, transmitting, by said server, said particular video to said first client in response to said request from said first client for said particular video.

4. The method according to claim 1, further comprising:
in response to said request from said first client to receive said particular video, billing, by said server, said first client for said particular video regardless of whether or not said second client has said first block of said video.

5. The method according to claim 1, further comprising:
receiving, by said second client, said particular video;
during said second client receiving said particular video, receiving, by said second client, said instruction from said server to transmit said particular video to said first client; and
concurrently with said second client receiving said particular video, transmitting, by said second client, said particular video to said first client.

6. The method according to claim 1, further comprising:
transmitting, by said server to said second client, a network packet that includes said instruction and a network address of said first client;
utilizing, by said second client, said network address to generate network packets that include said particular video; and
transmitting said particular video from said second client to said first client utilizing said generated network packets.

7. The method according to claim 1, further comprising:
receiving, by said second client, requested videos from said server;
storing said received requested videos in a first-in-first-out (FIFO) buffer that is included in said second client; and
determining, by said server, whether said second client has said first block of said particular video by determining, by said server, whether said first block of said particular video is stored in said FIFO buffer.

8. An apparatus for improving video-on-demand (VOD) content delivery in regional networks, said apparatus comprising:
a VOD server coupled to a plurality of different regional VOD networks;
a plurality of clients coupled to each one of said plurality of regional VOD networks;
said server for receiving a request from a first client in a first one of said plurality of regional VOD networks to receive a particular video, said first client being coupled to said first one of said plurality of regional VOD networks;
said server for determining whether a second client that is coupled to said first one of said plurality of regional VOD networks has a first block of said video;
in response to said second client having said first block of said video, said server transmitting an instruction to said second client to transmit said particular video to said first client; and
said server refraining from transmitting said particular video to said first client in response to said request from said first client for said particular video.

9. The apparatus according to claim 8, further comprising:
said second client transmitting said particular video to said first client.

10. The apparatus according to claim 8, further comprising:
in response to said second client not having said first block of said video, said server transmitting said particular video to said first client in response to said request from said first client for said particular video.

11. The apparatus according to claim 8, further comprising:
in response to said request from said first client to receive said particular video, said server billing said first client for said particular video regardless of whether or not said second client has said first block of said video.

12. The apparatus according to claim 8, further comprising:
said second client receiving said particular video;
during said second client receiving said particular video, said second client receiving said instruction from said server to transmit said particular video to said first client; and
said second client transmitting said particular video to said first client concurrently with said second client receiving said particular video.

13. The apparatus according to claim 8, further comprising:
said server transmitting to said second client a network packet that includes said instruction and a network address of said first client;
said second client utilizing said network address to generate network packets that include said particular video; and
said second client transmitting said particular video to said first client utilizing said generated network packets.

14. The apparatus according to claim 8, further comprising:
said second client receiving requested videos from said server;
a first-in-first-out (FIFO) buffer that is included in said second client for storing said received requested videos; and
said server determining whether said second client has said first block of said particular video by said server determining whether said first block of said particular video is stored in said FIFO buffer.

15. A computer program product for improving video-on-demand (VOD) content delivery in regional networks, said product comprising:
a VOD server coupled to a plurality of different regional VOD networks;
a plurality of clients coupled to each one of said plurality of regional VOD networks;
instructions for receiving, by said server, a request from a first client in a first one of said plurality of regional VOD networks to receive a particular video, said first client being coupled to said first one of said plurality of regional VOD networks;
instructions for determining, by said server, whether a second client that is coupled to said first one of said plurality of regional VOD networks has a first block of said video;
in response to said second client having said first block of said video, instructions for transmitting, by said server, an instruction to said second client to transmit said particular video to said first client; and
said server refraining from transmitting said particular video to said first client in response to said request from said first client for said particular video.

16. The product according to claim 15, further comprising:
instructions for transmitting from said second client to said first client said particular video.

17. The product according to claim 15, further comprising:
in response to said second client not having said first block of said video, instructions for transmitting, by said server, said particular video to said first client in response to said request from said first client for said particular video.

18. The product according to claim 15, further comprising:
in response to said request from said first client to receive said particular video, instructions for billing, by said server, said first client for said particular video regardless of whether or not said second client has said first block of said video.

19. The product according to claim 15, further comprising:
instructions for receiving, by said second client, said particular video;
during said second client receiving said particular video, instructions for receiving, by said second client, said instruction from said server to transmit said particular video to said first client; and
instructions for concurrently with said second client receiving said particular video, transmitting, by said second client, said particular video to said first client.

20. The product according to claim 15, further comprising:
instructions for transmitting, by said server to said second client, a network packet that includes said instruction and a network address of said first client;
instructions for utilizing, by said second client, said network address to generate network packets that include said particular video; and
instructions for transmitting said particular video from said second client to said first client utilizing said generated network packets.
